(19) United States
(12) Patent Application Publication
(10) Pub. No.: US 2025/0021372 A1
(43) Pub. Date: Jan. 16, 2025

(54) CONTROLLER, DATA STORAGE DEVICE, COMPUTING SYSTEM AND HOST SYSTEM

(71) Applicant: SK hynix Inc., Gyeonggi-do (KR)

(72) Inventors: Jung Min CHOI, Gyeonggi-do (KR); Hyun Chul KIM, Gyeonggi-do (KR)

(21) Appl. No.: 18/518,446

(22) Filed: Nov. 23, 2023

(30) Foreign Application Priority Data
Jul. 11, 2023 (KR) 10-2023-0089494
Aug. 24, 2023 (KR) 10-2023-0111114

(51) Int. Cl. G06F 9/455

(52) U.S. Cl. CPC G06F 9/45558; G06F 2009/4557; G06F 2009/45583

(57) ABSTRACT

In an embodiment of the disclosed technology, when a virtual machine is migrated between a plurality of host devices which are allocated with and use memory regions of a data storage device, data related to the virtual machine may be migrated without using a bandwidth between the data storage device and the host devices or by minimizing use of a bandwidth.

### CROSS-REFERENCE TO RELATED APPLICATION

The present application claims priority under 35 U.S.C. § 119 (a) to Korean Patent Application No. 10-2023-0089494 filed on Jul. 11, 2023 and Korean Patent Application No. 10-2023-0111114 filed on Aug. 24, 2023, which are incorporated herein by reference in their entirety.

### BACKGROUND

### 1. Technical Field

Various embodiments of the present disclosure generally relate to a controller, a data storage device, a computing system and a host system.

### 2. Related Art

A data storage device may include a memory device including a plurality of memory cells which store data. The data storage device may include a controller which controls the operation of the memory device.

A host device may perform a necessary workload using the data storage device. In an example, at least two host devices may perform workloads while sharing the data storage device.

The at least two host devices may perform workloads according to, for example, instructions from a host management server. Workloads of the host devices may not be even, and in this case, processing performance by the host devices may degrade.

### SUMMARY

Various embodiments of the disclosed technology are directed to providing measures capable of improving the processing performance of a computing system including at least two host devices which process workloads while sharing a data storage device located outside.

In an embodiment of the present disclosure, a data storage device may include: at least one memory device including a plurality of memory regions; and a controller configured to, when receiving a virtual machine migration command from a first virtual machine among a plurality of virtual machines operating in a first host device among a plurality of host devices, set at least one memory region other than a first memory region allocated to the first virtual machine among the plurality of memory regions, as a temporary memory region, and migrate data stored in the first memory region and corresponding to the virtual machine migration command, to the temporary memory region.

In an embodiment of the present disclosure, a computing system may include: a first host device; a second host device; and a data storage device configured to set, when receiving a virtual machine migration command from a first virtual machine operating in the first host device, at least one memory region other than a first memory region allocated to the first virtual machine, as a temporary memory region, migrate data stored in the first memory region and corresponding to the virtual machine migration command, to the temporary memory region, and allocate, when migration of the data is completed, the temporary data region to a second virtual machine operating in the second host device.

In an embodiment of the present disclosure, a data storage device may include: at least one memory device including a plurality of memory regions; and a controller connected to at least one host device, and configured to control the at least one memory device, wherein, when receiving a memory region allocation request from a first virtual machine among one or more virtual machines operating in a first host device among the at least one host device, the controller allocates a first memory region among the plurality of memory regions to the first virtual machine, and updates ownership information of the first memory region, and wherein, when receiving an ownership change request for the first memory region from the first virtual machine, the controller changes the ownership information of the first memory region and transmits a change completion message to the first host device.

According to the embodiments of the disclosed technology, it is possible to provide measures capable of improving the processing performance of a computing system in which at least two host devices process workloads while sharing a data storage device.

### BRIEF DESCRIPTION OF THE DRAWINGS

FIG. 1 is a diagram illustrating an example of the configurations of a data storage device and a host system based on an embodiment of the disclosed technology.

FIGS. 2 to 5 are diagrams illustrating an example of a method in which the data storage device and the host system based on the embodiment of the disclosed technology perform virtual machine migration.

FIGS. 6 and 7 are diagrams illustrating an example of another method in which the data storage device and the host system based on the embodiment of the disclosed technology perform virtual machine migration.

FIGS. 8 to 10 are diagrams illustrating an example of another method in which the data storage device and the host system based on the embodiment of the disclosed technology perform virtual machine migration.

FIGS. 11 to 15 are diagrams illustrating an example of another method in which the data storage device and the host system based on the embodiment of the disclosed technology perform virtual machine migration.

FIGS. 16 to 18 are diagrams illustrating an example of another method in which the data storage device and the host system based on the embodiment of the disclosed technology perform virtual machine migration.

### DETAILED DESCRIPTION

In the following description of various embodiments of the present disclosure, reference will be made to the accompanying drawings in which it is shown by way of illustration specific embodiments that can be implemented, and in which the same reference numerals and signs can be used to designate the same or like components even when they are shown in different accompanying drawings from one another. Further, in the following description of embodiments of the present disclosure, detailed descriptions of well-known functions and components incorporated herein will be omitted when it is determined that the description may make the subject matter in some embodiments of the present disclosure rather unclear. The terms such as “including”, “having”, “containing”, “constituting” “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the present disclosure. Each of these terms is not used to define essence, order, sequence, or number of elements etc., but is used merely to distinguish the corresponding element from other elements.

When it is disclosed that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap”, etc. each other.

When time relative terms, such as “after,” “subsequent to,” “next,” “before,” and the like, are used to describe processes or operations of elements or configurations, or flows or processes in operating, processing, manufacturing methods, these terms may be used to describe non-consecutive or non-sequential processes or operations unless the term “directly” or “immediately” is used together.

In addition, when any dimensions, relative sizes etc. are disclosed, it should be considered that numerical values for elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all meanings of the term “can”.

Hereinafter, various embodiments of the present disclosure will be described in detail with reference to accompanying drawings.

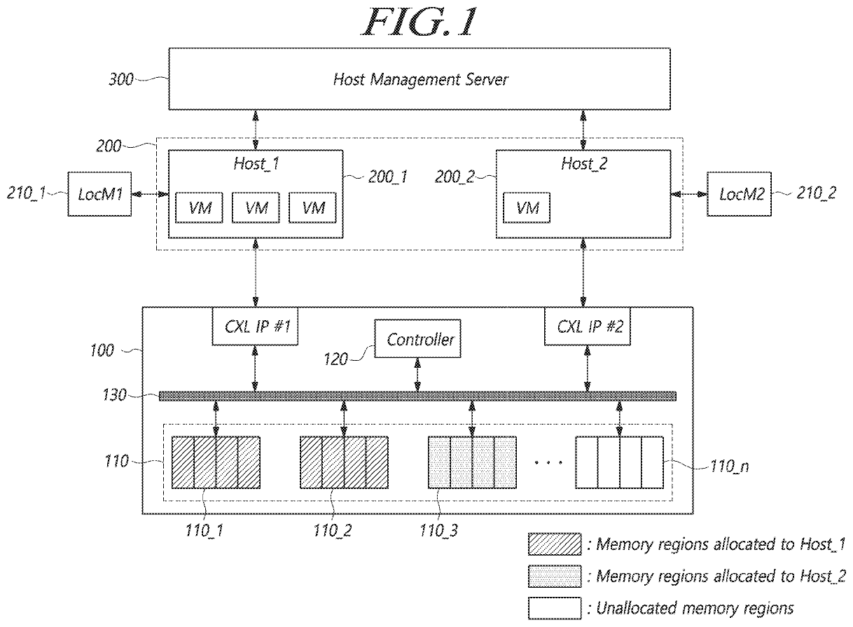

FIG. 1 is a diagram illustrating an example of the configurations of a data storage device 100 and a host system based on an embodiment of the disclosed technology.

Referring to FIG. 1, the data storage device 100 based on the embodiment of the disclosed technology may include, for example, a plurality of memory devices 110 and a controller 120. The plurality of memory devices 110 and the controller 120 may communicate through a bus 130. FIG. 1 shows as an example a case where the data storage device 100 includes n number of memory devices 110_1, 110_2, 110_3, . . . and 110_n. In the present specification, the data storage device 100 including the plurality of memory devices 110 and the controller 120 may be referred to as a memory system or a data storage system.

Each of the plurality of memory devices 110 may be, for example, a volatile memory such as a DRAM, an SDRAM, a DDR SDRAM, an LPDDR SDRAM and a GRAM, but the embodiment of the disclosed technology is not limited thereto. In an example, each of the plurality of memory devices 110 may be a nonvolatile memory. Alternatively, some of the plurality of memory devices 110 may be volatile memories, and other memory devices may be nonvolatile memories. In addition, the embodiment of the disclosed technology may be applied even when only one memory device 110 is included in the data storage device 100.

The data storage device 100 may allocate or deallocate memory regions (or memory sections) included in the plurality of memory devices 110, according to a request of a host device 200 which is located outside. The data storage device 100 may perform an operation of writing or erasing data to or in a memory region allocated to the host device 200 or reading data of a memory region, according to a request of the host device 200.

For example, the data storage device 100 may allocate the memory regions included in the plurality of memory devices 110 while communicating with one host device 200. Alternatively, the data storage device 100 may allocate the memory regions included in the plurality of memory devices 110 while communicating with at least two host devices 200. FIG. 1 shows as an example a case where the data storage device 100 allocates the memory regions included in the plurality of memory devices 110 while communicating with two host devices, i.e., a first host device (Host_1) 200_1 and a second host device (Host_2) 200_2.

For example, the host device 200 may be a computer, an ultra mobile PC (UMPC), a workstation, a personal digital assistant (PDA), a tablet, a mobile phone, a smartphone, an e-book, a portable multimedia player (PMP), a portable game player, a navigation device, a black box, a digital camera, a digital multimedia broadcasting (DMB) player, a smart television, a digital audio recorder, a digital audio player, a digital picture recorder, a digital picture player, a digital video recorder, a digital video player, a storage configuring a data center, one of various electronic devices configuring a home network, one of various electronic devices configuring a telematics network, a radio frequency identification (RFID) device, a mobility device (e.g., a vehicle, a robot or a drone) capable of driving under human control or autonomous driving, or the like. Alternatively, the host device 200 may be a virtual/augmented reality (VR/AR) device which provides a 2D or 3D virtual reality image or augmented reality image. The host device 200 is not limited to the above examples and may be any one of various electronic devices which require the data storage device 100 capable of storing data.

The host device 200 may include at least one operating system. The operating system may manage and control overall functions and operations of the host device 200. The operating system may control an interoperation between the host device 200 and the data storage device 100. The operating system may be classified into a general operating system and a mobile operating system depending on the mobility of the host device 200.

The host device 200 and the data storage device 100 may be collectively referred to as a computing system.

The host device 200 may perform communication with the data storage device 100 through a preset interface.

For example, the host device 200 may communicate with the data storage device 100 through the Compute Express Link (CXL) interface. Since the host device 200 communicates with the data storage device 100 through the CXL interface, a low-latency high-bandwidth access environment may be implemented in a structure which communicates with the data storage device 100 including the plurality of memory devices 110 each having high capacity.

Alternatively, in an example, the host device 200 may communicate with the data storage device 100 through an interface other than the CXL interface.

For example, the host device 200 and the data storage device 100 may communicate through at least one among various communication interfaces or standards such as a USB (universal serial bus) protocol, an MMC (multimedia card) protocol, a PCI (peripheral component interconnection) protocol, a PCI-e or PCIe (PCI-express) protocol, an ATA (advanced technology attachment) protocol, a serial-ATA protocol, a parallel-ATA protocol, an SCSI (small computer system interface) protocol, an ESDI (enhanced small disk interface) protocol and an IDE (integrated drive electronics) protocol, but are not limited thereto.

As such, the type and number of host devices 200 which perform communication with the data storage device 100 based on the embodiment of the disclosed technology and a communication interface between the host device 200 and the data storage device 100 may be various. However, hereinafter, a case where at least two host devices 200 communicate with the data storage device 100 through the CXL interface will be described as an example.

The controller 120 of the data storage device 100 may allocate or deallocate the memory regions included in the plurality of memory devices 110, according to a request of the host device 200. For example, the controller 120 may mean a microcontroller unit distinguished from a memory controller which controls the operation of each of the plurality of memory devices 110. Alternatively, in an example, the controller 120 may be provided by being integrated with the memory controller just described above.

For example, the controller 120 may allocate to a first host device 200_1 the memory regions included in a first memory device 110_1 and a second memory device 110_2 according to a request of the first host device 200_1. The controller 120 may allocate to a second host device 200_2 the memory regions included in a third memory device 110_3 according to a request of the second host device 200_2.

In an example, the controller 120 may allocate some of the memory regions included in the first memory device 110_1 to the first host device 200_1, and other memory regions included in the first memory device 110_1 may be allocated to the second host device 200_2.

A separate memory controller which is distinguished from the controller 120 and corresponds to each of the plurality of memory devices 110 may be disposed in the data storage device 100 and may control an operation of processing data with respect to the memory device 110. The memory controller may control an operation of writing or erasing data to or in a memory region of the memory device 110 or reading data of a memory region of the memory device 110, according to a request of the host device 200. In this case, the controller 120 may be disposed separately from the memory controller which corresponds to each of the plurality of memory devices 110 and may perform control on management of memory regions including allocation of the memory regions and so on.

Alternatively, in the case where the controller 120 is provided by being integrated with the memory controller, the controller 120 may control allocation and management of memory regions and the operation of the memory device 110.

The host device 200 may perform a workload using a memory region allocated from the data storage device 100. The workload performed by the host device 200 may be represented as a virtual machine (VM). An allocation request transmitted by the host device 200 to the data storage device 100 may be regarded as being transmitted by the host device 200 or may be regarded as being transmitted by one of a plurality of virtual machines which operate in the host device 200. In order to perform work related to a virtual machine, the host device 200 may use a memory region which is located inside or outside.

For example, the host device 200 may use the memory region of a local memory 210 which corresponds to each host device 200. The local memory 210 may include a first local memory (LocM1) 210_1 and a second local memory (LocM2) 210_2.

The first host device 200_1 may use the first local memory 210_1, and the second host device 200_2 may use the second local memory 210_2. Also, as described above, the host device 200 may use memory regions allocated from the data storage device 100.

The local memory 210 may be a memory which is located adjacent to the host device 200 or is located inside the host device 200. The local memory 210 may be a volatile memory such as an SRAM, a DRAM, an SDRAM, a DDR SDRAM, an LPDDR SDRAM and a GRAM, but is not limited thereto.

The at least two host devices 200 may be controlled by a host management server 300, for example. The host management server 300, and the first host device 200_1 and the second host device 200_2 controlled by the host management server 300 may be collectively referred to as a host system.

As described above, the host device 200 may perform work corresponding to a virtual machine using the local memory 210 which corresponds to each of the at least two host devices 200 and memory regions allocated from the data storage device 100.

There may occur a state in which workloads according to virtual machines performed by the at least two host devices 200 are uneven. An operation of migrating a virtual machine performed by one of the at least two host devices 200 to another may be performed.

The embodiment of the disclosed technology may provide measures capable of preventing or reducing a communication delay due to an operation of migrating a virtual machine and improving the processing performance of the host device 200 through migration of a virtual machine between the at least two host devices 200.

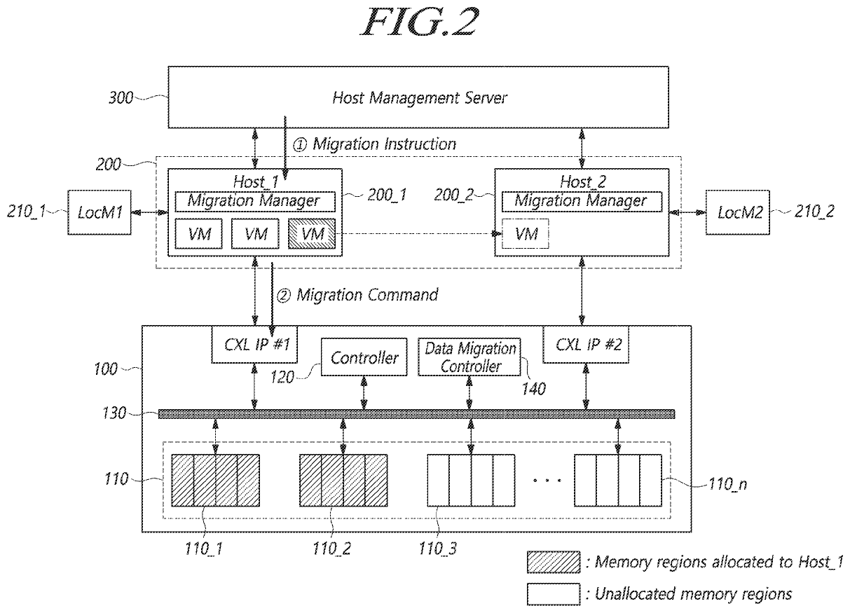

FIGS. 2 to 5 are diagrams illustrating a method in which the data storage device 100 and the host system based on the embodiment of the disclosed technology perform virtual machine migration.

FIGS. 2 to 5 show as an example a case where the first host device 200_1 and the second host device 200_2 perform work according to a virtual machine while sharing the data storage device 100. The first host device 200_1 may use the first local memory 210_1 which is adjacent to the first host device 200_1. The second host device 200_2 may use the second local memory 210_2 which is adjacent to the second host device 200_2. The first host device 200_1 and the second host device 200_2 may operate under the control of the host management server 300.

Referring to FIG. 2, a state in which the first host device 200_1 performs workloads according to at least two virtual machines and the second host device 200_2 does not perform a workload according to a virtual machine is shown as an example. A case where a plurality of virtual machines operate in the first host device 200_1 and no virtual machine operates in the second host device 200_2 is shown as an example.

The first host device 200_1 may use the memory region of the first local memory 210_1 and some of the memory regions of the data storage device 100. For example, the first host device 200_1 may be allocated with and use the memory regions of the first memory device 110_1 and the memory regions of the second memory device 110_2, which are included in the data storage device 100. It may be regarded that virtual machines operating in the first host device 200_1 are allocated with memory regions.

The second host device 200_2 may be in a state in which it is not allocated with a memory region of the memory device 110 included in the data storage device 100. Alternatively, the second host device 200_2 may be in a state in which it is allocated with a memory region of the memory device 110 included in the data storage device 100.

An operation of migrating a virtual machine being performed in the first host device 200_1 to the second host device 200_2 may be performed under the control of the host management server 300.

For example, the host management server 300 may instruct the first host device 200_1 to migrate a virtual machine to the second host device 200_2 (\textcircled{1}).

The first host device 200_1 may perform an operation to migrate the virtual machine as a target to be migrated. During at least a partial period before migration of the virtual machine is completed, the first host device 200_1 may perform work according to the corresponding virtual machine. The operation related to the migration of the virtual machine may be performed by a migration manager which is included in the first host device 200_1.

The migration manager of the first host device 200_1 may transmit a migration-related signal to the second host device 200_2 according to the migration instruction of the host management server 300. Alternatively, the host management server 300 may transmit a migration-related signal to the second host device 200_2.

The second host device 200_2 may include a migration manager. The migration manager included in the second host device 200_2 may perform a preparation for being migrated with the virtual machine according to the migration-related signal received from the first host device 200_1 or the host management server 300.

The migration manager of the first host device 200_1 may control migration of data required in relation to the migration of the virtual machine.

For example, the first host device 200_1 may transmit to the second host device 200_2 data related to the virtual machine as a migration target among data stored in the first local memory 210_1. The corresponding data may be stored in the second local memory 210_2 which is adjacent to the second host device 200_2.

The first host device 200_1 may control an operation for transferring to the second host device 200_2 data related to the virtual machine as a migration target among data stored in the memory regions of the data storage device 100, which are allocated to the first host device 200_1.

For example, the migration manager of the first host device 200_1 may transmit a migration command to the data storage device 100 (\textcircled{2}). The migration command may be one which is generated and transmitted by the virtual machine as a migration target.

According to the migration command received from the first host device 200_1, the data storage device 100 may perform an operation for migrating data related to the virtual machine as a migration target and stored in the memory device 110 included in the data storage device 100. For example, the operation for data migration may be performed by the controller 120 included in the data storage device 100. Alternatively, the operation for data migration may be performed by a controller unit which is disposed separately from the controller 120. A controller unit which manages data migration may be disposed separately. In this case, the controller unit may output only a signal for controlling data migration or may directly control an operation of migrating data while controlling data migration.

Data to be migrated by the data storage device 100 may be moved inside the data storage device 100. It is possible to prevent or reduce the occurrence of a communication delay between the data storage device 100 and the host device 200 due to migration of data according to migration of a virtual machine.

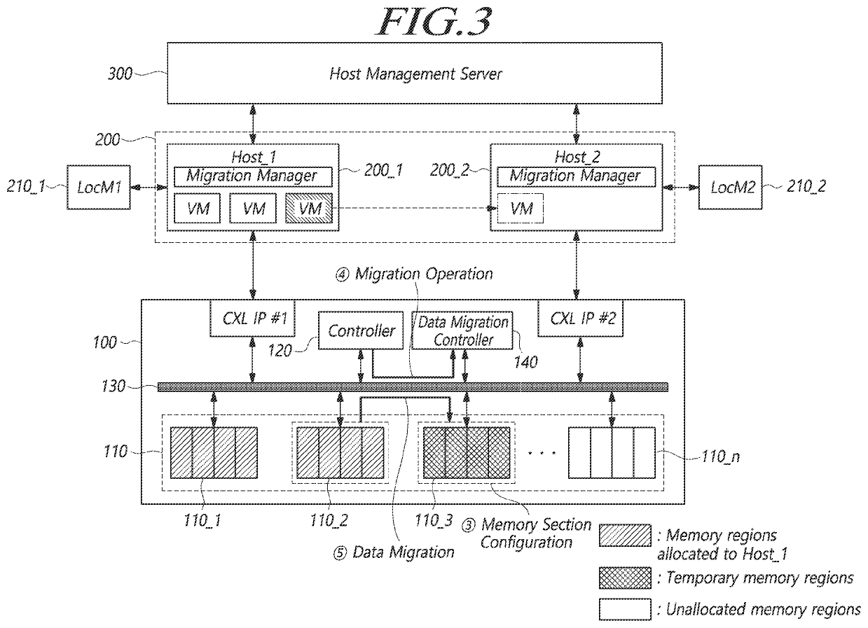

Referring to the illustrated example of FIG. 3, the controller 120 included in the data storage device 100 may set or configure a temporary memory region (section) (or a free memory region) when receiving the migration command from the first host device 200_1 (\textcircled{3}). A case where an operation corresponding to the migration command according to the embodiment of the disclosed technology is performed by the controller 120 is described as an example. However, as described above, an operation corresponding to the migration command may be performed by a controller unit which is disposed separately from the controller 120.

The temporary memory region may be a region which is secured for migration of data related to the virtual machine as a migration target. The temporary memory region may be a region in which data is not stored. The temporary memory region may be a region which is not allocated to the host device 200.

The temporary memory region may be set as a memory region which is not allocated to the host device 200, in the memory device 110 including a memory region in which data related to the virtual machine as a migration target is stored. For example, in the case where data related to the virtual machine as a migration target is stored in the first memory device 110_1, the temporary memory region may be set as at least a part of memory regions which are not allocated to the host device 200 among the memory regions included in the first memory device 110_1.

Alternatively, the temporary memory region may be set as a memory region which is included in the memory device 110 other than the memory device 110 including a memory region in which data related to the virtual machine as a migration target is stored. For example, in the case where data related to the virtual machine as a migration target is stored in the first memory device 110_1, the temporary memory region may be set as at least a part of memory regions which are included in the memory device 110 other than the first memory device 110_1, such as the second memory device 110_2 or the third memory device 110_3.

In some embodiments, the temporary memory region may be a part of memory regions which are allocated to the host device 200 to which the virtual machine as a migration target is to be migrated. For example, in the case where a virtual machine in which a work is being performed by the first host device 200_1 is to be migrated to the second host device 200_2, the temporary memory region may be, as a part of memory regions allocated to the second host device 200_2, a region in which data is not stored or a region in a state in which it is not used by the second host device 200_2.

FIG. 3 shows as an example a case where the controller 120 sets memory regions included in the third memory device 110_3, being memory regions not allocated to the host device 200, as temporary memory regions. Further, FIG. 3 shows as an example a case where data related to the virtual machine as a migration target is stored in the memory regions included in the second memory device 110_2.

When receiving the migration command from the first host device 200_1 and setting the temporary memory regions, the controller 120 may control an operation for migrating data related to the virtual machine in the data storage device 100.

In some embodiments, the data storage device 100 may include a data migration controller 140. The data migration controller 140 may be, for example, a direct memory access (DMA) controller.

The controller 120 may instruct the data migration controller 140 to migrate data stored in the memory regions included in the second memory device 110_2 and related to the virtual machine to temporary memory regions included in the third memory device 110_3 (\textcircled{4}).

According to the instruction of the controller 120, the data migration controller 140 may perform an operation of migrating data related to the virtual machine as a migration target among data stored in the memory regions included in the second memory device 110_2 to the temporary memory regions included in the third memory device 110_3 (\textcircled{5}).

Since the operation of migrating data is performed by the data migration controller 140, the controller 120 may control the data storage device 100 while performing other operations.

Since data related with the virtual machine as a migration target is migrated in the data storage device 100, it is possible to prevent or reduce the occurrence of a communication delay between the host device 200 and the data storage device 100 or a communication delay between the host devices 200 due to data migration.

When migration of data related to the virtual machine as a migration target in the data storage device 100 is completed, the controller 120 may transmit a signal notifying the outside that data migration has been completed.

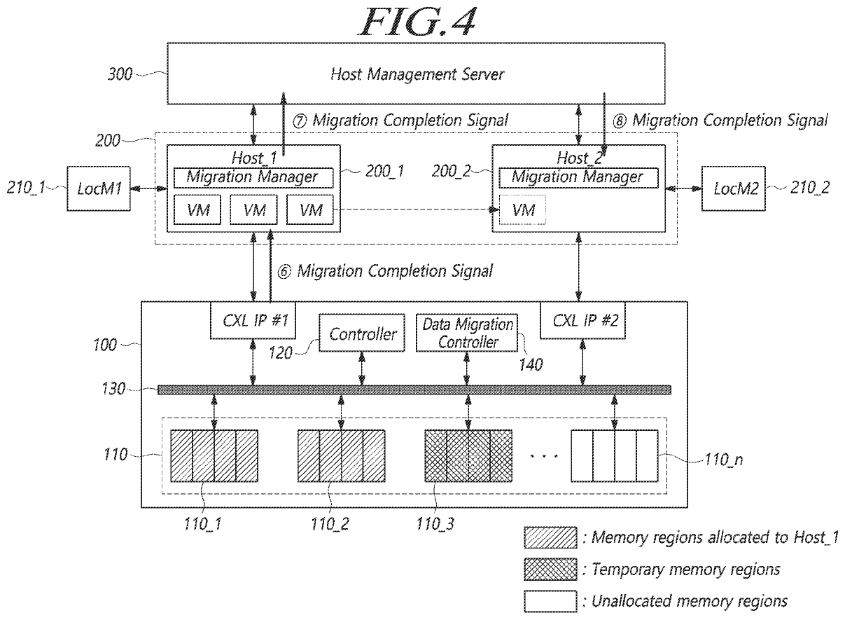

In the illustrated example of FIG. 4, when data migration according to migration of the virtual machine is completed in the data storage device 100, the controller 120 may transmit a migration completion signal to the first host device 200_1 which transmitted the migration command (\textcircled{6}).

The first host device 200_1, which has received the migration completion signal, may stop work on the virtual machine as a migration target. Alternatively, the first host device 200_1, which has received the migration completion signal, may be in a state in which it has stopped a work on the virtual machine as a migration target.

The first host device 200_1 may transmit to the host management server 300 a migration completion signal or a signal corresponding to the migration completion signal (\textcircled{7}). Alternatively, the first host device 200_1 may transmit a migration completion signal or a signal corresponding to the migration completion signal to the second host device 200_2 to which the virtual machine is to be migrated.

When receiving the migration completion signal or the signal corresponding to the migration completion signal from the first host device 200_1, the host management server 300 may transmit a signal the same as or corresponding to the migration completion signal or the signal corresponding to the migration completion signal, to the second host device 200_2. (\textcircled{8}).

The second host device 200_2 may receive the migration completion signal or the signal corresponding to the migration completion signal from the host management server 300 or the first host device 200_1. After transmitting the migration completion signal, the first host device 200_1 may directly transmit a part of data related to the virtual machine as a migration target to the second host device 200_2. For example, data related to the virtual machine as a migration target and stored in the first host device 200_1 or the first local memory 210_1 which is adjacent to the first host device 200_1 may be transmitted to the second host device 200_2.

The second host device 200_2 may recognize that migration of data related to migration of the virtual machine in the data storage device 100 has been completed. When recognizing that migration of data related to the virtual machine in the data storage device 100 is completed, the second host device 200_2 may request the data storage device 100 to allocate memory regions in which the data related to the virtual machine is stored.

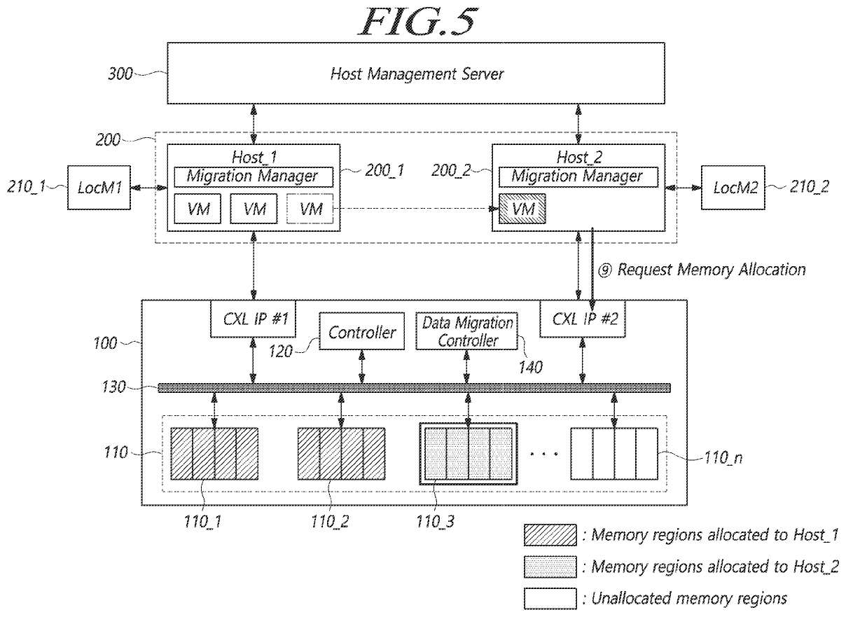

In the illustrated example of FIG. 5, the second host device 200_2 may transmit to the data storage device 100, a request for allocation of the temporary memory regions (\textcircled{9}).

According to the allocation request of the second host device 200_2, the controller 120 of the data storage device 100 may allocate to the second host device 200_2 the memory regions included in the third memory device 110_3 as the temporary memory regions.

Memory regions in the data storage device 100 in which the data related to the virtual machine as a migration target is stored may be allocated to the second host device 200_2 to which the virtual machine has been migrated.

Since all of the data related with the virtual machine as a migration target are in a state in which they may be used, the migration manager included in the second host device 200_2 may resume work according to the migrated virtual machine. Work according to the virtual machine migrated from the first host device 200_1 may be performed by the second host device 200_2.

Since work according to the virtual machine to be performed by the first host device 200_1 is performed by being migrated to the second host device 200_2, evenness in the works according to virtual machines between the host devices 200 may increase, and processing performance by the host devices 200 may be improved.

In addition, in the process in which the virtual machine is migrated, since the data stored in the memory regions of the data storage device 100 allocated to the host device 200 is migrated in the data storage device 100, the migration of the virtual machine may be completed while a communication delay between the host device 200 and the data storage device 100 is prevented or reduced.

In the embodiment of the disclosed technology, since tracing of a dirty page which occurs during migration of the data related to the virtual machine is performed in the data storage device 100, it is possible to further reduce influence exerted on communication between the data storage device 100 and the host device 200 by the operation according to the migration of the virtual machine.

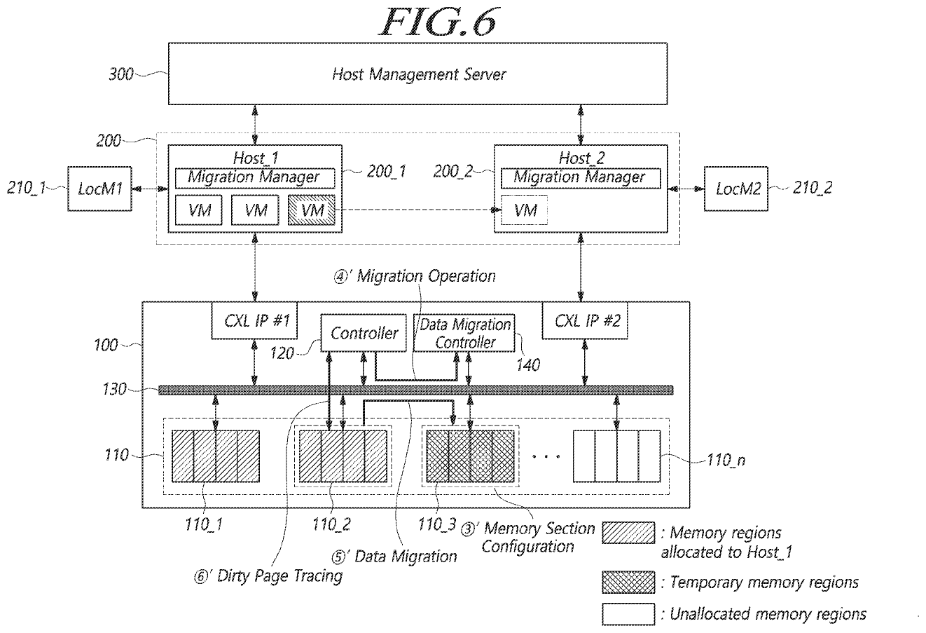

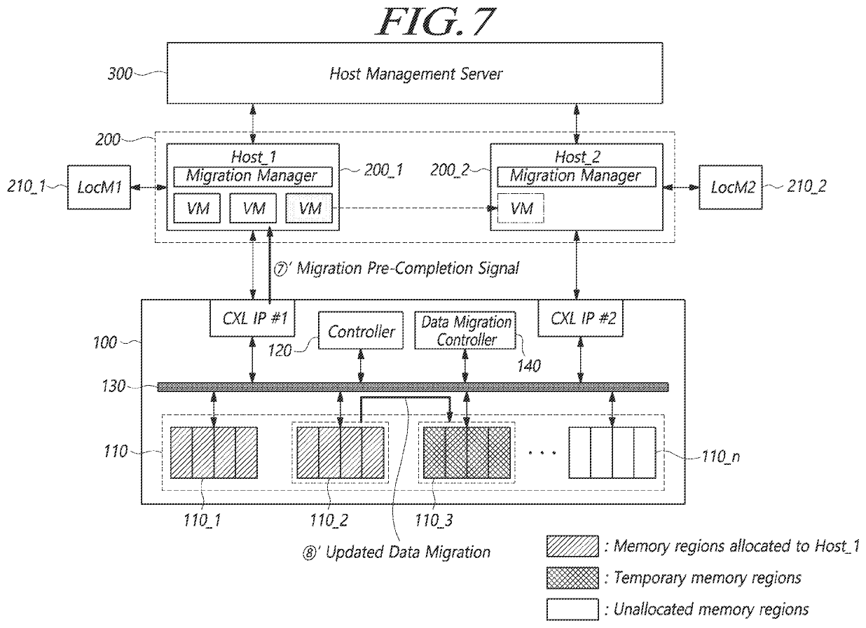

FIGS. 6 and 7 are diagrams illustrating another method in which the data storage device 100 and the host system based on the embodiment of the disclosed technology perform virtual machine migration. FIGS. 6 and 7 show as an example process portions different from the method shown in FIGS. 2 to 5 in the virtual machine migration operation described above with reference to FIGS. 2 to 5.

FIG. 6 shows a case where work according to a virtual machine being performed by the first host device 200_1 is migrated to the second host device 200_2. The first host device 200_1, which has received a migration instruction from the host management server 300, may transmit a migration command to the data storage device 100.

The controller 120 of the data storage device 100 may receive the migration command from the first host device 200_1.

The controller 120 may set or configure temporary memory regions (sections) according to the migration command (\textcircled{3})′). A method in which the controller 120 sets the temporary memory regions may be similar to that of the example described above. For example, the controller 120 may set, as the temporary memory regions, memory regions included in the third memory device 110_3, being memory regions not allocated to the host device 200.

The controller 120 may instruct the data migration controller 140 to perform migration of data related to the virtual machine as a migration target (\textcircled{4})′).

According to the instruction of the controller 120, the data migration controller 140 may perform an operation of migrating data stored in the memory regions included in the second memory device 110_2 and related to the virtual machine as a migration target, to the temporary memory regions included in the third memory device 110_3 (\textcircled{5′}).

Even after transmitting a signal regarding migration of the virtual machine to the data storage device 100, the second host device 200_2 and so on, the first host device 200_1 may perform work according to the virtual machine as a migration target. The data related to the virtual machine as a migration target may be updated according to the work performed by the first host device 200_1.

For example, the data stored in the memory regions included in the second memory device 110_2 of the data storage device 100 and related to the virtual machine as a migration target may be updated.

The controller 120 of the data storage device 100 may trace that the data related to the virtual machine as a migration target is updated by the first host device 200_1, while data migration is performed in the data storage device 100 (\textcircled{7′}). The dirty page tracing may mean to trace an update of the data related to the virtual machine during a period that the data migration is performed. The data to be migrated may be updated during the period that data migration is performed, and the controller 120 may check the update of the data related to the virtual machine. Thus, the updated data may be transferred additionally after the data migration period is finished.

Since the data migration operation is controlled by the data migration controller 140, the controller 120 may trace the update of the data related to the virtual machine by the first host device 200_1 while data migration is performed.

The controller 120 may trace the update of the data related to the virtual machine by the first host device 200_1, and may manage information on updated data. For example, the controller 120 may store information on the update of the data related to the virtual machine by the first host device 200_1, in a separate memory which is included in the controller 120 or the data storage device 100.

When migration of the data related to the virtual machine as a migration target is completed by the data migration controller 140, the controller 120 may instruct the data migration controller 140 to migrate data updated while the data migration operation is performed.

According to an instruction of the controller 120, the data migration controller 140 may perform migration of data updated while a previous data migration operation is performed.

Since tracing of updated data is performed by the controller 120, communication between the first host device 200_1 and the data storage device 100 for tracing update of data while the data migration operation is performed may not be performed. In relation to the data migration operation, movement of data or communication performed between the data storage device 100 and the host device 200 may be reduced.

Since movement of data or communication between the data storage device 100 and the host device 200 is reduced while the data migration operation is performed, a communication delay due to the data migration operation may be prevented or reduced.

In some embodiments, work according to another virtual machine to be performed by the host device 200 may be performed without being affected by the migration operation of the data related to the virtual machine as a migration target. Data migration according to migration of a virtual machine may be performed without deteriorating the performance of work according to another virtual machine.

In this way, dirty page tracing may be performed by the controller 120 in the data storage device 100 while the data migration operation is performed, and data updated while the data migration operation is performed may be additionally migrated.

While the updated data is additionally migrated, work according to the virtual machine by the first host device 200_1 may be performed.

The controller 120 may trace update of data as a migration target according to performing the work according to the virtual machine by the first host device 200_1. The controller 120 may repeatedly trace update of data as a migration target and instruct additional migration of updated data.

When a time required for updated data to be additionally migrated is equal to or shorter than a predetermined time, the controller 120 may perform data migration in a state in which work according to the virtual machine by the first host device 200_1 is stopped.

In the illustrated example of FIG. 7, when a time required to migrate updated data is equal to or shorter than a preset threshold value, the controller 120 may transmit a migration pre-completion signal to the first host device 200_1 (\textcircled{7′}). The migration pre-completion signal may be a signal which is transmitted from the data storage device 100 to the host device 200 before transmission of a migration completion signal.

For example, when receiving the migration pre-completion signal, the first host device 200_1 may stop work according to the virtual machine as a migration target.

In a state in which work according to the virtual machine as a migration target is stopped, the controller 120 may perform migration of data updated during a previous data migration period (i.e., updated data migration \textcircled{8′}).

While migration of data related to the virtual machine as a migration target is performed in the data storage device 100, update of the data related to the virtual machine may not be performed. Dirty page tracing by the controller 120 may not be performed.

When data migration is completed in a state in which work according to the virtual machine as a migration target is stopped, the controller 120 may transmit a migration completion signal to the first host device 200_1.

Operations after the migration completion signal is transmitted by the controller 120 may be performed similarly to those of the method described above with reference to FIGS. 2 to 5.

As is apparent from the above description, a data migration operation according to migration of a virtual machine is performed in the data storage device 100, and dirty page tracing is performed by the controller 120 while the data migration operation is performed. Therefore, influence exerted on communication between the data storage device 100 and the host device 200 by transmission and reception of data according to migration of the virtual machine may be minimized or reduced.

Data migration may be performed while preventing or reducing a communication delay, and deterioration in communication performance due to work according to another virtual machine performed by the host device 200 may not occur.

In some embodiments, when data migration according to migration of a virtual machine is performed in the data storage device 100, data stored in the local memory 210 and related to the virtual machine as a migration target may be migrated in the data storage device 100.

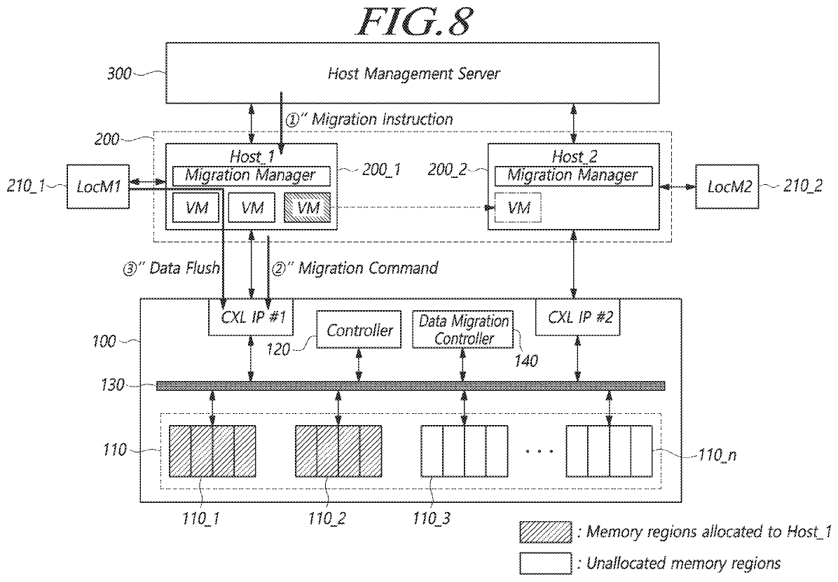

FIGS. 8 to 10 are diagrams illustrating an example of another method in which the data storage device 100 and the host system based on the embodiment of the disclosed technology perform virtual machine migration. FIGS. 8 to 10 show as an example process portions different from the method shown in FIGS. 2 to 5 in the virtual machine migration operation described above with reference to FIGS. 2 to 5.

Referring to FIG. 8, a migration instruction may be transmitted to the first host device 200_1 by the host management server 300 (\textcircled{1}″).

The migration manager of the first host device 200_1 may transmit a migration command to the data storage device 100 (\textcircled{2}″). In addition, the migration manager of the first host device 200_1 may transmit information related to migration of a virtual machine to the migration manager of the second host device 200_2.

When the command regarding migration of the virtual machine is transmitted by the first host device 200_1 to the data storage device 100, data related to the virtual machine as a migration target among data stored in the first local memory 210_1 may be flushed into the data storage device 100 (\textcircled{3}″).

For example, the first host device 200_1 may perform work according to the virtual machine as a migration target and may store data related to the corresponding virtual machine in the first local memory 210_1 or memory regions allocated from the data storage device 100. The first host device 200_1 may perform work according to the virtual machine using the memory region of the first local memory 210_1 and the memory regions allocated from the data storage device 100.

When migration of the virtual machine is determined, the first host device 200_1 may move to the data storage device 100 data stored in the memory region of the first local memory 210_1 and related to the virtual machine as a migration target, so that the data may be migrated together with data in the data storage device 100.

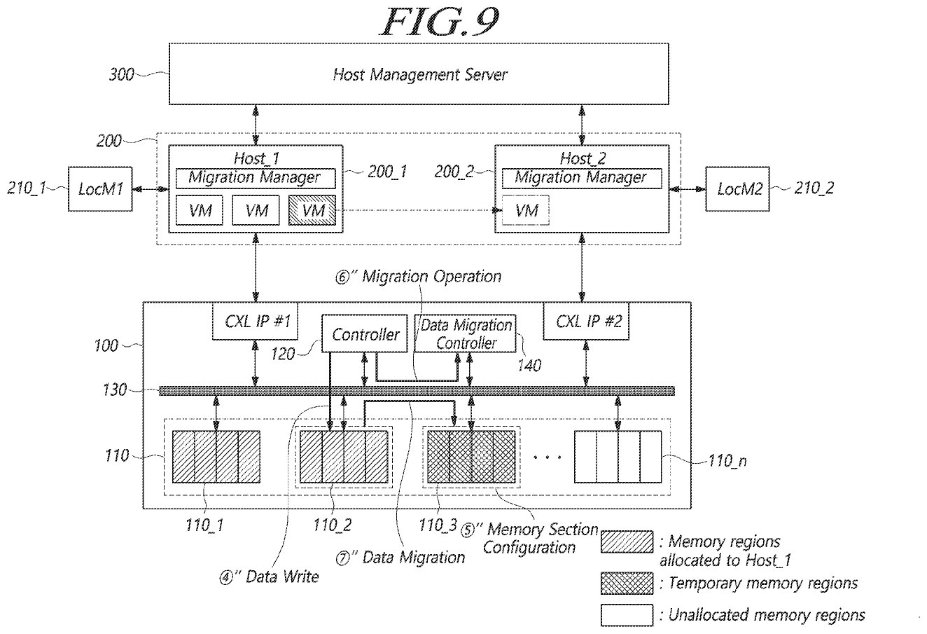

In the illustrated example of FIG. 9, at the same time as or after receiving the migration command from the first host device 200_1, when data stored in the first local memory 210_1 and related to the virtual machine as a migration target is received, the controller 120 of the data storage device 100 may store the received data in memory regions allocated to the first host device 200_1 (\textcircled{4}″).

In the present specification, the data related to the virtual machine as a migration target and moved from the local memory 210 to the memory regions of the data storage device 100 may be referred to as additional data.

The controller 120 may store the additional data received from the first host device 200_1 in memory regions which are allocated to the first host device 200_1 and in which data to be migrated is stored. For example, the controller 120 may store the additional data in the memory regions which are included in the second memory device 110_2.

The controller 120 may set or configure temporary memory regions (or sections) according to the migration command received from the first host device 200_1 (\textcircled{5}″).

For example, the controller 120 may set or configure the memory regions included in the third memory device 110_3 as the temporary memory regions.

The controller 120 may instruct the data migration controller 140 to migrate to the temporary memory regions data related to the virtual machine as a migration target and stored in the second memory device 110_2 (\textcircled{6}″).

According to the instruction received from the controller 120, the data migration controller 140 may migrate the data stored in the second memory device 110_2 and related to the virtual machine as a migration target to the temporary memory regions included in the third memory device 110_3.

The data migration controller 140 may also migrate the additional data stored in the second memory device 110_2 and moved from the first local memory 210_1 to the temporary memory regions included in the third memory device 110_3.

Data stored using the local memory 210 and the memory regions of the data storage device 100 and related to the virtual machine as a migration target may be migrated in the data storage device 100.

While data migration is performed by the data migration controller 140, work according to the virtual machine as a migration target may be performed by the first host device 200_1. Data related to the virtual machine as a migration target may be updated by the first host device 200_1.

The controller 120 may trace a dirty page while data migration is performed.

When data migration is completed by the data migration controller 140, the controller 120 may control the data migration controller 140 so that data updated during a corresponding period may be additionally migrated.

When a period required for data to be additionally migrated is equal to or shorter than a preset threshold value (or threshold period), the controller 120 may cause updated data to be migrated in a state in which work according to the virtual machine as a migration target by the first host device 200_1 is stopped.

When migration of data related to the virtual machine as a migration target in the data storage device 100 is completed, the controller 120 may transmit a signal notifying the first host device 200_1 that data migration has been completed.

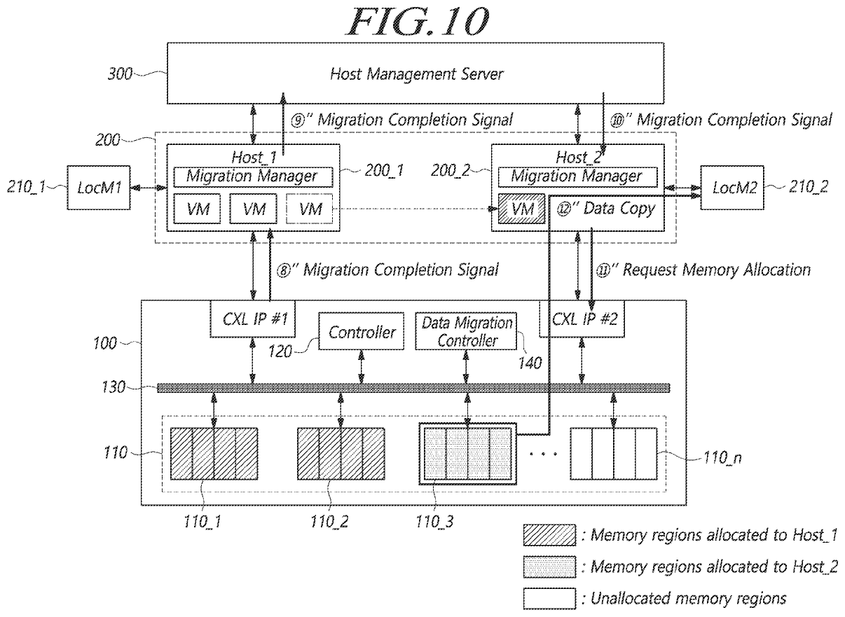

In the illustrated example of FIG. 10, the controller 120 may transmit a migration completion signal to the first host device 200_1 (\textcircled{8}″).

The first host device 200_1 may transmit to the host management server 300 a migration completion signal or a signal corresponding to the migration completion signal (\textcircled{9}″). Alternatively, the first host device 200_1 may transmit the corresponding signal to the second host device 200_2.

When the host management server 300 receives the migration completion signal from the first host device 200_1, the host management server 300 may transmit to the second host device 200_2 a migration completion signal or a signal corresponding to the migration completion signal (\textcircled{10}″).

The second host device 200_2 may transmit to the controller 120 of the data storage device 100 an allocation request for memory regions in which the data related to the virtual machine as a migration target is stored (\textcircled{11}″).

The temporary memory regions in which the data related to the virtual machine as a migration target is stored may be allocated to the second host device 200_2 by the controller 120 of the data storage device 100.

The work according to the migrated virtual machine may be resumed by the second host device 200_2.

In an example, the data moved from the first local memory 210_1 among the data stored in the temporary memory regions may be moved (copied) to the second local memory 210_2 which is adjacent to the second host device 200_2 (\textcircled{12}″).

While work according to the migrated virtual machine is performed by the first host device 200_1, data stored in the first local memory 210_1 may be moved to the second local memory 210_2. While work according to the migrated virtual machine is performed by the first host device 200_1, data stored in the data storage device 100 may be moved to the memory regions allocated to the second host device 200_2 in the data storage device 100.

Since data related to the virtual machine as a migration target and stored in the local memory 210 and data related to the virtual machine as a migration target and stored in the data storage device 100 may be migrated in the data storage device 100, a communication delay due to data migration may be prevented or reduced.

Since tracing of data updated while data migration is performed and movement of additional data are performed in the data storage device 100, migration of the virtual machine may be performed while further reducing data communication between the data storage device 100 and the host device 200 according to data migration.

The embodiment of the disclosed technology may provide measures capable of managing data migration according to migration of a virtual machine while minimizing data movement in the data storage device 100.

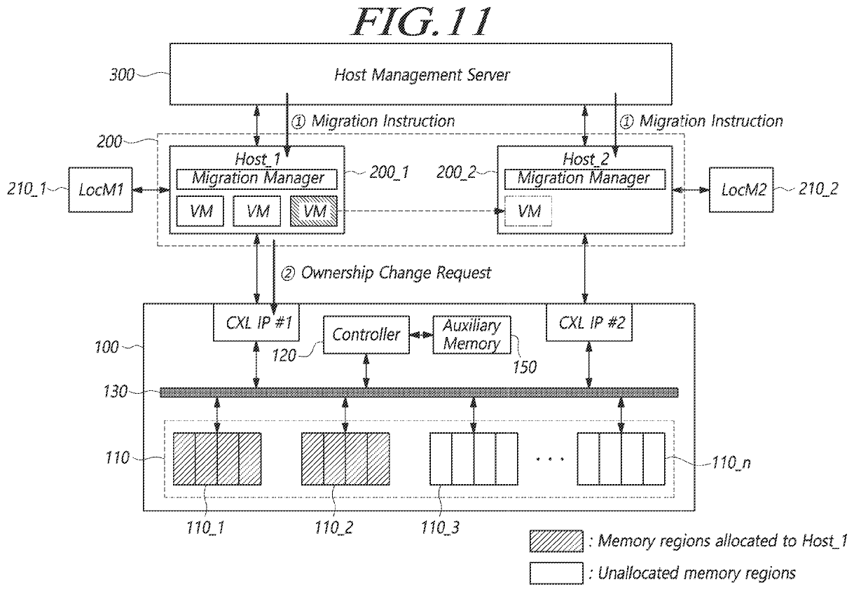

FIGS. 11 to 15 are diagrams illustrating an example of another method in which the data storage device 100 and the host system based on the embodiment of the disclosed technology perform virtual machine migration.

FIG. 11 shows as an example a case where the first host device 200_1 and the second host device 200_2 perform work according to a virtual machine while sharing the data storage device 100. The first host device 200_1 may use the first local memory 210_1 which is adjacent to the first host device 200_1. The second host device 200_2 may use the second local memory 210_2 which is adjacent to the second host device 200_2. The first host device 200_1 and the second host device 200_2 may operate under the control of the host management server 300.

FIG. 11 shows as an example a state in which the first host device 200_1 performs workloads according to at least two virtual machines and the second host device 200_2 does not perform a workload according to a virtual machine. In an example, a case where a plurality of virtual machines operate in the first host device 200_1 and no virtual machine operates in the second host device 200_2 is shown.

The first host device 200_1 may use the memory region of the first local memory 210_1 and some of the memory regions of the data storage device 100. For example, the first host device 200_1 may be allocated with and use the memory regions of the first memory device 110_1 included in the data storage device 100 and the memory regions of the second memory device 110_2 included in the data storage device 100. It may be regarded that virtual machines operating in the first host device 200_1 are allocated with memory regions.

The second host device 200_2 may be in a state in which it is not allocated with a memory region of the memory device 110 included in the data storage device 100. Alternatively, the second host device 200_2 may be in a state in which it is allocated with a memory region of the memory device 110 included in the data storage device 100.

An operation of migrating a virtual machine being performed in the first host device 200_1 to the second host device 200_2 may be performed under the control of the host management server 300.

For example, the host management server 300 may instruct the first host device 200_1 to migrate a virtual machine to the second host device 200_2 (\textcircled{1}). Also, the host management server 300 may transmit an instruction for migration of the virtual machine, to the second host device 200_2 (\textcircled{1}). The first host device 200_1 and the second host device 200_2 may perform operations necessary for migrating the virtual machine, according to the migration instruction of the host management server 300.

For example, the first host device 200_1 may transmit a command or request regarding migration of the virtual machine, to the data storage device 100. The second host device 200_2 may allocate resources for receiving the virtual machine. The second host device 200_2 may not transmit a separate request to the data storage device 100.

The first host device 200_1 may transmit, to the data storage device 100, an ownership change request requesting that the ownership information of memory regions allocated to the virtual machine to be migrated be changed (\textcircled{2}). The first host device 200_1 may stop the operation of the virtual machine as a migration target before transmitting the ownership change request.

The controller 120 of the data storage device 100 may manage the ownership information of memory regions allocated to the host device 200 or virtual machines operating in the host device 200.

For example, the data storage device 100 may include an auxiliary memory 150. The auxiliary memory 150 may be a volatile memory such as an SRAM, a DRAM, an SDRAM, a DDR SDRAM, an LPDDR SDRAM and a GRAM, but is not limited thereto.

When allocating memory regions according to an allocation request of the host device 200, the controller 120 may update the ownership information of the corresponding memory regions. The controller 120 may store and manage the ownership information of the memory regions in the auxiliary memory 150.

Since the memory regions of the first memory device 110_1 and the memory regions of the second memory device 110_2 included in the data storage device 100 are allocated to the virtual machines operating in the first host device 200_1, the ownership information of the corresponding memory regions may be stored as the first host device 200_1 or the virtual machines operating in the first host device 200_1.

When receiving, from the first host device 200_1, the ownership change request according to migration of the virtual machine, the controller 120 may change the ownership information of memory regions allocated to the virtual machine. The controller 120 may update an ownership information table which is stored in the auxiliary memory 150.

The controller 120 may change the ownership information of the memory regions allocated to the virtual machine to be migrated, from the first host device 200_1 to the second host device 200_2 to which the virtual machine is to be migrated.

Alternatively, the controller 120 may change the ownership information of the memory regions allocated to the virtual machine as a migration target, after responding to the ownership change request of the first host device 200_1.

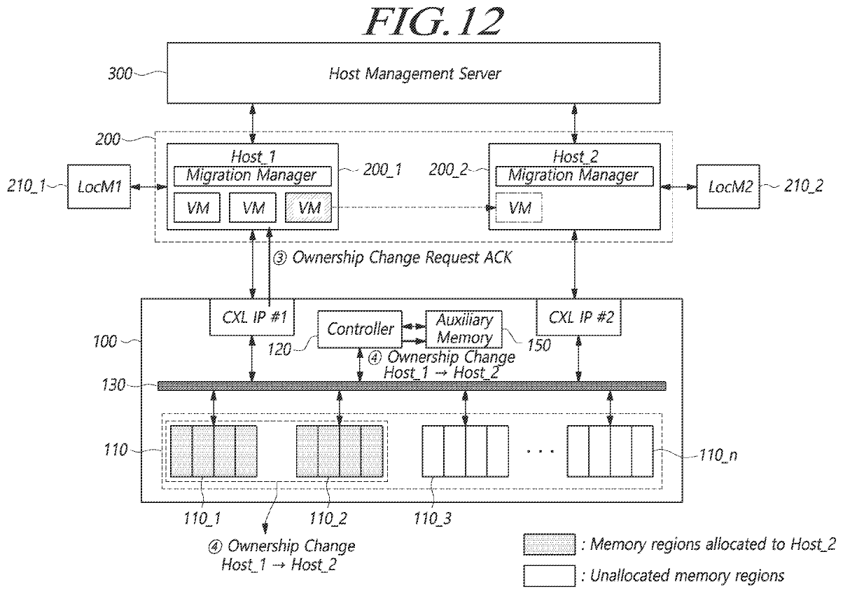

In the illustrated example of FIG. 12, when receiving the ownership change request of the first host device 200_1, the controller 120 of the data storage device 100 may transmit an ownership change request acknowledgement (ACK) signal to the first host device 200_1 (\textcircled{3}).

When a preparation for changing the ownership of the corresponding memory regions is completed in response to the ownership change request of the first host device 200_1, the controller 120 may transmit the ownership change request acknowledgement signal to the first host device 200_1.

As in the example described above with reference to FIG. 11, the first host device 200_1 may stop the operation of the virtual machine as a migration target before transmitting an ownership change request to the data storage device 100. Alternatively, when receiving the ownership change request acknowledgement signal from the controller 120 of the data storage device 100, the first host device 200_1 may stop the operation of the virtual machine as a migration target.

The controller 120 may transmit the ownership change request acknowledgement signal to the first host device 200_1 and may change the ownership information of the memory regions allocated to the virtual machine as a migration target, to the second host device 200_2 (\textcircled{4}). In an example, there may be a time interval between a time point at which the ownership change request acknowledgement signal is transmitted and a time point at which ownership information is changed.

The controller 120 may change the ownership of the memory regions allocated to the virtual machine as a migration target, in the ownership information table stored in the auxiliary memory 150.

Since the ownership of the memory regions is changed by the controller 120, data related to the virtual machine as a migration target may not be actually moved in the data storage device 100, and the ownership of the memory regions in which the corresponding data is stored may be transferred to the second host device 200_2 to which the virtual machine is migrated.

Data transfer according to migration of the virtual machine may be possible without actual data movement. A delay time may be reduced when migrating the virtual machine, and a bandwidth between the data storage device 100 and the host device 200 may not be used due to data movement.

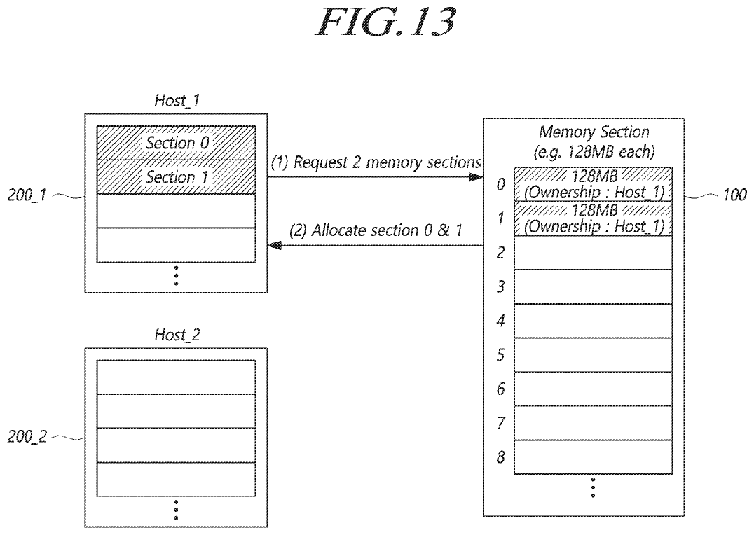

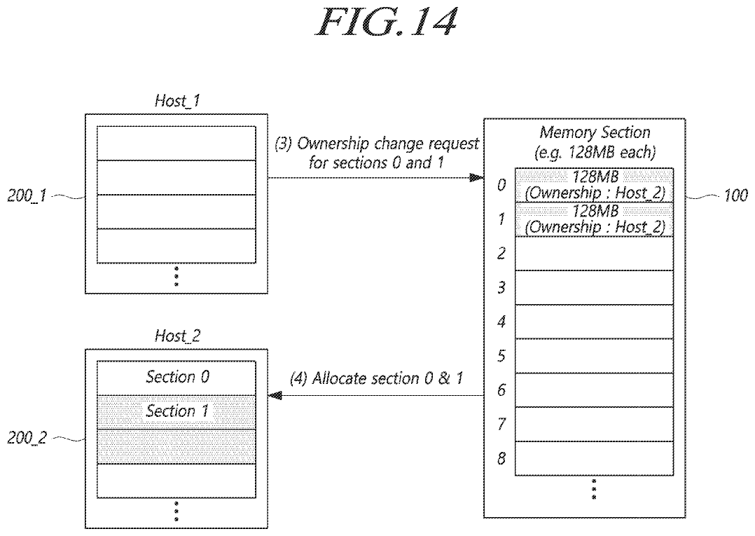

A method of changing the ownership of memory regions is described with reference to FIGS. 13 and 14. According to an allocation request of the first host device 200_1, memory regions (or memory sections) included in the data storage device 100 may be allocated to the first host device 200_1. FIGS. 13 and 14 show, as an example, a case where the size of one memory region is 128 MB, but the size of memory regions based on the embodiment of the disclosed technology is not limited thereto.

In the illustrated example of FIG. 13, the first host device 200_1 may transmit an allocation request for two memory regions (sections) to the data storage device 100 as shown in (1). In response to the allocation request of the first host device 200_1, the data storage device 100 may allocate memory regions (sections) 0 and 1 to the first host device 200_1 as shown in (2).

The controller 120 of the data storage device 100 may update the ownership information of the memory region 0 and the memory region 1 among the memory regions included in the data storage device 100, as the first host device 200_1.

When receiving the ownership change request from the first host device 200_1, the controller 120 may change the ownership of the memory regions allocated to the first host device 200_1.

In the illustrated example of FIG. 14, the first host device 200_1 may request the data storage device 100 to change the ownership information of the memory region (section) 0 and the memory region (section) 1 to the second host device 200_2 as shown in (3).

When receiving the ownership change request from the first host device 200_1, the controller 120 of the data storage device 100 may change the ownership information of the memory region 0 and the memory region 1 to the second host device 200_2 in the ownership information table stored in the auxiliary memory 150.

Data stored in the memory region 0 and the memory region 1 are not moved, and the ownership information of the memory region 0 and the memory region 1 may be changed.

The controller 120 may transmit to the second host device 200_2 a signal notifying that the memory region 0 and the memory region 1 are allocated to the second host device 200_2, as shown in (4).

The second host device 200_2 may check, according to the allocation signal received from the controller 120, that the memory region 0 and the memory region 1 are allocated to the second host device 200_2 and may perform work according to the virtual machine using the corresponding memory regions.

In this way, data related to the virtual machine to be migrated may not be moved outside or inside the data storage device 100, and may be used by the second host device 200_2 to which the virtual machine is to be migrated.

In some embodiments, the first host device 200_1 may notify completion of ownership information change to the second host device 200_2 so that the second host device 200_2 is able to use the memory regions whose ownership has been changed.

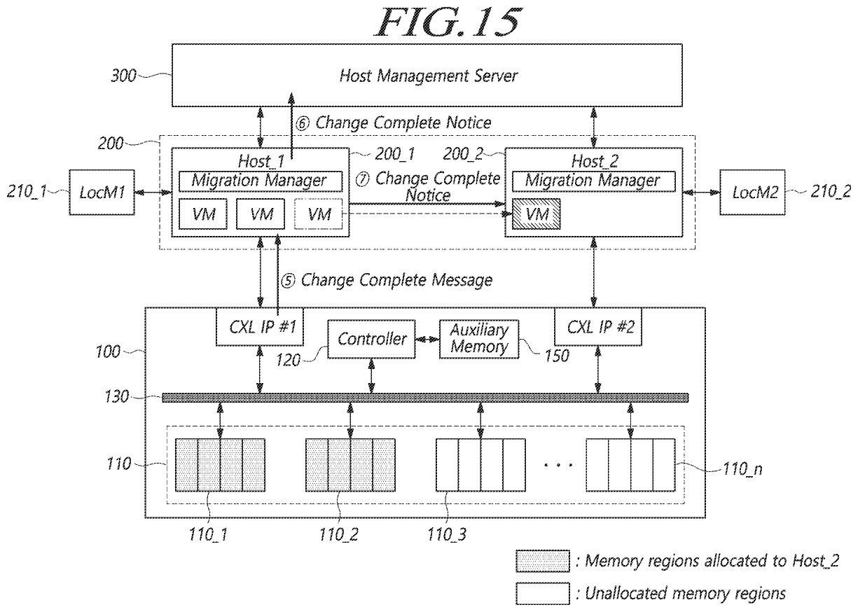

In the illustrated example of FIG. 15, when ownership change of the memory regions allocated to the virtual machine as a migration target is completed in response to the ownership change request of the first host device 200_1, the controller 120 of the data storage device 100 may transmit a change completion (or complete) message to the first host device 200_1 (\textcircled{5}). In some embodiments, in the case where the first host device 200_1 stops the operation of the virtual machine as a migration target before transmitting the ownership change request to the data storage device 100, the controller 120 of the data storage device 100 may transmit to the first host device 200_1 the ownership change request acknowledgement signal corresponding to the ownership change request as the change completion message. Depending on a time point at which the first host device 200_1 stops the operation of the virtual machine as a migration target, the number and types of signals or messages which the controller 120 of the data storage device 100 transmits to the first host device 200_1 may be different.

When receiving the change completion message, the first host device 200_1 may transmit a change completion (or complete) notice to the host management server 300 (\textcircled{6}).

The host management server 300, which has received the change completion notice, may transmit a change completion notice to the second host device 200_2. The migration instruction indicating the migration start of the virtual machine and the change completion notice indicating the migration end of the virtual machine may be transmitted to the second host device 200_2 by the host management server 300.

Alternatively, the first host device 200_1, which has received the change completion message, may transmit a change completion (or complete) notice to the second host device 200_2 (\textcircled{7}).

The second host device 200_2, which has received the change completion notice from the outside, may start work according to the migrated virtual machine using the memory regions of the data storage device 100 whose ownership has been changed.

Alternatively, the controller 120 of the data storage device 100 may transmit a change completion message to the second host device 200_2. The controller 120 may transmit a change completion message to the first host device 200_1 and transmit a change completion message to the second host device 200_2.

The controller 120 may provide the second host device 200_2 with information on the memory regions whose ownership has been changed to the second host device 200_2.

With data related to the virtual machine as a migration target not moved in the data storage device 100, the second host device 200_2 to which the virtual machine is to be migrated may access the data.

Without movement of data related to the virtual machine as a migration target, a second virtual machine corresponding to a first virtual machine operating in the first host device 200_1 may operate in the second host device 200_2.

In some embodiments, additional data related to the virtual machine as a migration target may be stored in the first local memory 210_1 which is adjacent to the first host device 200_1.

The additional data stored in the first local memory 210_1 may be, for example, data frequently used by the virtual machine. The additional data may be data which is related to the virtual machine and has a frequency of use higher than data stored in the data storage device 100.

The additional data stored in the first local memory 210_1 may be transmitted from the first host device 200_1 to the second host device 200_2 according to the migration of the virtual machine.

The additional data may be transmitted after the migration of the virtual machine is completed or may be transmitted after the operation of the virtual machine as a migration target is stopped in the first host device 200_1.

The additional data may be transmitted through a network between the first host device 200_1 and the second host device 200_2 and may be stored in the second local memory 210_2 which is adjacent to the second host device 200_2.

In some embodiments, the additional data stored in the first local memory 210_1 may be provided to the second host device 200_2 through the data storage device 100.

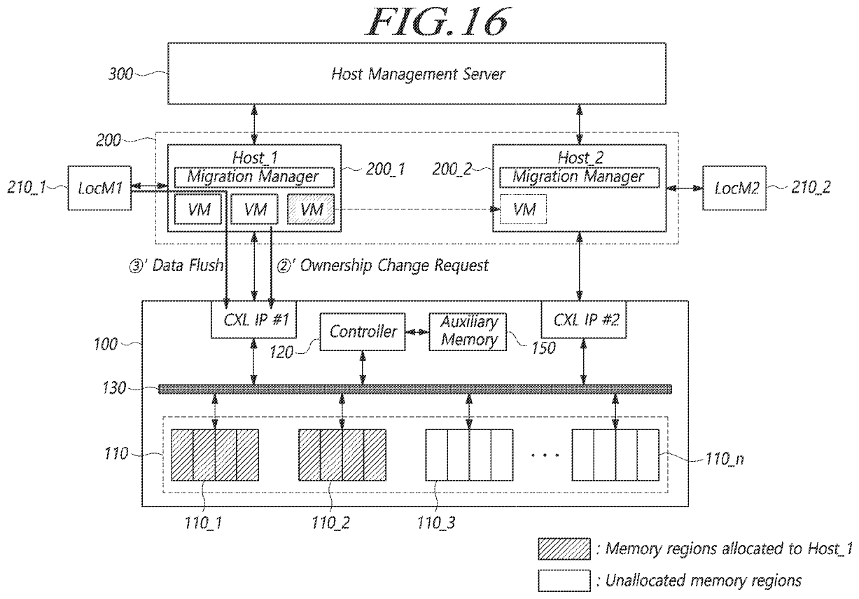

FIGS. 16 to 18 are diagrams illustrating an example of another method in which the data storage device 100 and the host system based on the embodiment of the disclosed technology perform virtual machine migration.

In the illustrated example of FIG. 16, according to a migration instruction of the host management server 300, the first host device 200_1 may transmit an ownership change request to the data storage device 100 (\textcircled{2}′).

The first host device 200_1 may perform an operation of flushing additional data stored in the first local memory 210_1 and related to a virtual machine as a migration target, to the data storage device 100 (\textcircled{3}′).

For example, the first host device 200_1 may start the operation of flushing the additional data to the data storage device 100, before transmitting the ownership change request. Alternatively, the first host device 200_1 may start the operation of flushing the additional data to the data storage device 100, simultaneously with the ownership change request or after transmitting the ownership change request.

Before starting the operation of flushing the additional data to the data storage device 100, the first host device 200_1 may stop the operation of the virtual machine as a migration target.

Alternatively, regardless of whether the additional data is transmitted, the first host device 200_1 may stop the operation of the virtual machine as a migration target before transmitting the ownership change request.

The additional data may be stored in memory regions allocated to the virtual machine as a migration target among the memory regions of the data storage device 100.

In the state in which the additional data is stored in the memory regions included in the data storage device 100, the ownership information of the memory regions allocated to the virtual machine as a migration target may be changed.

Alternatively, the additional data may be flushed to the data storage device 100 after the first host device 200_1 receives an ownership change request acknowledgement signal from the data storage device 100.

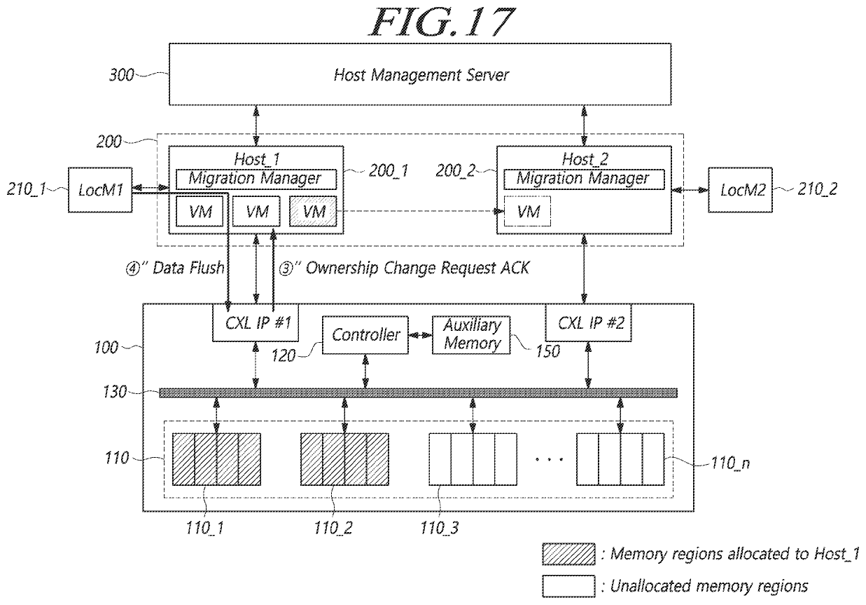

In the illustrated example of FIG. 17, in response to the ownership change request transmitted to the data storage device 100 by the first host device 200_1, the ownership change request acknowledgement (ACK) signal may be transmitted to the first host device 200_1 from the data storage device 100 (\textcircled{3}″).

After receiving the ownership change request acknowledgement signal, the first host device 200_1 may start an operation of flushing additional data stored in the first local memory 210_1 and related to the virtual machine as a migration target, to the data storage device 100 (\textcircled{4}″).

When receiving the ownership change request acknowledgement signal, the first host device 200_1 may stop the operation of the virtual machine as a migration target and flush the additional data stored in the first local memory 210_1 to the data storage device 100.

The additional data may be stored, before the ownership information of the memory regions allocated to the virtual machine as a migration target in the data storage device 100 is changed, in the corresponding memory regions.

The controller 120 may change, after the additional data is stored in the memory regions allocated to the virtual machine as a migration target, the ownership information of the corresponding memory regions.

The ownership of the corresponding memory regions may be changed from the first host device 200_1 to the second host device 200_2.

After the ownership of the corresponding memory regions is changed, the additional data may remain stored in the data storage device 100 or may be moved to the second local memory 210_2 which is adjacent to the second host device 200_2.

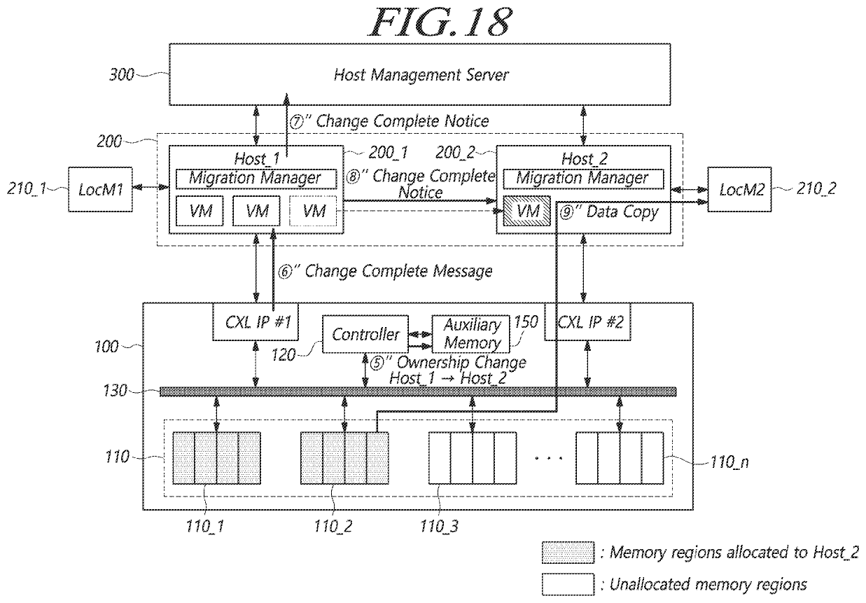

In the illustrated example of FIG. 18, after the additional data is stored in the memory regions allocated to the virtual machine as a migration target, the ownership of the corresponding memory regions may be changed from the first host device 200_1 to the second host device 200_2 (\textcircled{5}″).

The controller 120 of the data storage device 100 may transmit a change completion (or complete) message to the first host device 200_1 (\textcircled{6}″). In an example, the controller 120 may transmit a change completion message also to the second host device 200_2.

When receiving the change completion message, the first host device 200_1 may transmit a change completion (or complete) notice to the host management server 300 (\textcircled{7}″). The first host device 200_1 may transmit a change completion (or complete) notice to the second host device 200_2 (\textcircled{8}″).

The second host device 200_2 may start the operation of the migrated virtual machine in response to the received change completion notice. The second host device 200_2 may start the operation of the virtual machine using the memory regions which are included in the data storage device 100 and whose ownership has been changed.

The second host device 200_2 may start the operation of the virtual machine after moving the additional data stored in the memory regions of the data storage device 100 to the second local memory 210_2 before starting the operation of the migrated virtual machine (\textcircled{9}″).

The additional data may be moved to the second local memory 210_2 according to a request of the second host device 200_2 or may be moved to the second local memory 210_2 by the controller 120 of the data storage device 100.

The additional data stored in the first local memory 210_1 and moved to the memory regions of the data storage device 100 may be moved as it is to the second local memory 210_2. Alternatively, a part of the additional data and a part of data stored in the memory regions whose ownership has been changed may be moved to the second local memory 210_2.

The additional data may be transferred to the second host device 200_2 according to the migration of the virtual machine without passing through a network between the first host device 200_1 and the second host device 200_2.

As is apparent from the above description, according to the embodiment of the disclosed technology, in a process in which a virtual machine operating in the first host device 200_1 is migrated to the second host device 200_2, data related to the virtual machine as a migration target may be provided to the second host device 200_2 without movement of data between the host device 200 and the data storage device 100.

Furthermore, since the second host device 200_2 to which the virtual machine is migrated through the ownership change of memory regions included in the data storage device 100 may access the corresponding data, the data related to the virtual machine as a migration target may be provided to the second host device 200_2 even without movement of data in the data storage device 100.

In some embodiments, since additional data stored in the first local memory 210_1 and related to the virtual machine as a migration target may also be moved to the data storage device 100 and be provided to the second host device 200_2, the virtual machine may be moved from the first host device 200_1 to the second host device 200_2 with little use of a network between the first host device 200_1 and the second host device 200_2.

According to the embodiments of the disclosed technology, the migration efficiency of a virtual machine may be improved by reducing a delay due to data movement when migrating the virtual machine, and the operational performance of virtual machines by the plurality of host devices 200 may be improved.

The foregoing embodiments are briefly described below.

A data storage device according to embodiments of the present disclosure may comprise at least one memory device including a plurality of memory regions, and a controller configured to, when receiving a virtual machine migration command from a first virtual machine among a plurality of virtual machines operating in a first host device among a plurality of host devices, set at least one memory region other than a first memory region allocated to the first virtual machine among the plurality of memory regions, as a temporary memory region, and migrate data stored in the first memory region and corresponding to the virtual machine migration command, to the temporary memory region.

When migration of the data is completed, the controller may allocate the temporary memory region to a second virtual machine which operates in a second host device different from the first host device.

When migration of the data is completed, the controller may transmit a migration completion signal to the first host device.

After transmitting the migration completion signal, the controller may allocate the temporary memory region in response to an allocation request received from the second virtual machine which operates in the second host device.

The temporary memory region may be a memory region which is not allocated to the plurality of host devices.

The temporary memory region may be a part of memory regions allocated to the second virtual machine which operates in the second host device different from the first host device.

The controller may trace update of the data corresponding to the virtual machine migration command by the first virtual machine operating in the first host device while the data is migrated.

When migration of the data is completed, the controller may migrate to the temporary memory region the data updated by the first virtual machine operating in the first host device.

When a time period required to migrate the updated data is equal to or shorter than a preset threshold period, the controller may migrate the data in a state in which control of the first virtual machine operating in the first host device for the data corresponding to the virtual machine migration command is stopped.

The data storage device may further comprise a data migration controller configured to operate under control of the controller and perform a migration operation of the data.

The controller may receive an allocation request from at least one of multiple virtual machines operating in each of the plurality of host devices, and, in response to the allocation request, may allocate at least one of the plurality of memory regions as a memory region corresponding to at least one of the multiple virtual machines.

The controller may receive, from the first host device, additional data which is stored in a local memory adjacent to the first host device and corresponds to the virtual machine migration command. When receiving the additional data, the controller may store the additional data in the first memory region and may migrate the additional data to the temporary memory region.

The controller may store the additional data in the temporary memory region.

When migration of the data is completed, the additional data may be migrated to a local memory which is adjacent to the second host device different from the first host device.

A computing system according to embodiments of the present disclosure may comprise a first host device, a second host device, and a data storage device configured to set, when receiving a virtual machine migration command from a first virtual machine operating in the first host device, at least one memory region other than a first memory region allocated to the first virtual machine, as a temporary memory region, migrate data stored in the first memory region and corresponding to the virtual machine migration command, to the temporary memory region, and allocate, when migration of the data is completed, the temporary data region to a second virtual machine operating in the second host device.

The data storage device may trace update of the data corresponding to the virtual machine migration command by the first virtual machine operating in the first host device while the data is migrated, and additionally migrates updated data.

When receiving a migration pre-completion signal from the data storage device, the first host device may stop work by the first virtual machine related with the virtual machine migration command.

When receiving a migration completion signal from the data storage device, the first host device may transfer the migration completion signal to the outside of the data storage device.

The first host device may transmit data which is stored in the first host device or a local memory adjacent to the first host device and is related with the first virtual machine, to the second host device in which the second virtual machine operates.

The second virtual machine operating in the second host device may transmit an allocation request for the temporary memory region to the data storage device after the migration completion signal is transmitted by the data storage device.

A host system according to embodiments of the present disclosure may comprise a first host device, a second host device, and a host management server configured to manage the first host device and the second host device, wherein the first host device transmits, when receiving a migration instruction for a virtual machine from the host management server, a virtual machine migration command to a data storage device, and transfers, when receiving a migration completion signal from the data storage device, the migration completion signal to the host management server or the second host device, and wherein the second host device transmits, when receiving the migration completion signal from the host management server or the first host device, an allocation request for a memory region in which data related with the virtual machine is stored, to the data storage device.

A data storage device according to embodiments of the present disclosure may comprise at least one memory device including a plurality of memory regions, and a controller coupled to at least one host device, and configured to control the at least one memory device, wherein, when receiving a memory region allocation request from a first virtual machine among one or more virtual machines operating in a first host device among the at least one host device, the controller allocates a first memory region among the plurality of memory regions to the first virtual machine, and updates ownership information of the first memory region, and wherein, when receiving an ownership change request for the first memory region from the first virtual machine, the controller changes the ownership information of the first memory region and transmits a change completion message to the first host device.

After receiving the ownership change request, the controller may generate an ownership change request acknowledgement signal corresponding to the ownership change request and may transmit to the first host device the ownership change request acknowledgement signal as the change completion message.

After receiving the ownership change request, the controller may generate an ownership change request acknowledgement signal corresponding to the ownership change request and may transmit to the first host device the ownership change request acknowledgement signal before transmitting the change completion message.

The controller may transmit, in response to the ownership change request, at least one of the change completion message and information of the first memory region to a second host device which takes over ownership of the first memory region among the at least one host device.

A computing system according to embodiments of the present disclosure may comprise a first host device, a second host device, and a data storage device configured to manage ownership information of a memory region allocated to at least one of the first host device and the second host device, and, when receiving, from a first virtual machine among one or more virtual machines operating in the first host device, an ownership change request for a migration memory region allocated to the first virtual machine, change ownership information of the migration memory region from the first host device to the second host device.

When receiving a migration instruction for the first virtual machine from the outside of the data storage device, the first host device may stop an operation of the first virtual machine and may transmit the ownership change request to the data storage device.

When receiving an ownership change request acknowledgement signal corresponding to the ownership change request from the data storage device, the first host device may stop an operation of the first virtual machine.

When change of the ownership information of the migration memory region is completed, the first host device may receive a change completion message from the data storage device and may transmit a change completion notice to the second host device.

When receiving the change completion notice, the second host device may start an operation of a second virtual machine corresponding to the first virtual machine using the migration memory region.

Before transmitting the change completion notice, the first host device may transmit to the second host device additional data which is stored in a first local memory adjacent to the first host device and is related to the first virtual machine.

The second host device may store the additional data in a second local memory which is adjacent to the second host device.

Before the ownership information of the migration memory region is changed, the first host device may store in the migration memory region additional data which is stored in a first local memory adjacent to the first host device and is related to the first virtual machine.

Before transmitting the ownership change request, the first host device may request the data storage device to store the additional data in the migration memory region.

After the ownership information of the migration memory region is changed, the data storage device may move at least a part of the additional data to a second local memory which is adjacent to the second host device.

The data storage device may move to the second local memory a part of data other than the moved part of the additional data among data stored in the migration memory region.

A host system according to embodiments of the present disclosure may comprise a first host device, a second host device, and a host management server configured to manage the first host device and the second host device, wherein the first host device transmits, when receiving a migration instruction for a virtual machine from the host management server, an ownership change request for a migration memory region allocated to a first virtual machine among at least one virtual machine operating in the first host device, to a data storage device, and transmits, when receiving a change completion message from the data storage device, a change completion notice to the host management server or the second host device, and wherein the second host device starts, when receiving the change completion notice, an operation of a second virtual machine corresponding to the first virtual machine using the migration memory region.

When receiving the migration instruction, the first host device may stop an operation of the first virtual machine and may transmit the ownership change request to the data storage device.

When receiving an ownership change request acknowledgement signal corresponding to the ownership change request from the data storage device, the first host device may stop an operation of the first virtual machine.

Before transmitting the change completion notice, the first host device may transmit to the second host device additional data which is stored in a first local memory adjacent to the first host device and is related with the first virtual machine.

The second host device may store the additional data in a second local memory which is adjacent to the second host device.

Before the ownership information of the migration memory region is changed, the first host device may store in the migration memory region additional data which is stored in a first local memory adjacent to the first host device and is related with the first virtual machine.

Before transmitting the ownership change request, the first host device may request the data storage device to store the additional data in the migration memory region.

A controller according to embodiments of the present disclosure may comprise an element configured to: allocate at least one of a plurality of memory regions included in at least one memory device according to a memory region allocation request for at least one virtual machine operating in each of a plurality of host devices, manage ownership information of the plurality of memory regions, and, when receiving an ownership change request from a first virtual machine operating in a first host device, change ownership information of a migration memory region related to the first virtual machine from the first host device to a second host device and transmit a change completion message to the first host device.

After receiving the ownership change request, the controller may generate an ownership change request acknowledgement signal corresponding to the ownership change request and may transmit to the first host device the ownership change request acknowledgement signal as the change completion message.

After receiving the ownership change request, the controller may generate an ownership change request acknowledgement signal corresponding to the ownership change request and may transmit to the first host device the ownership change request acknowledgement signal before transmitting the change completion message.

The controller may transmit to the second host device at least one of the change completion message and information of the migration memory region.

Although various embodiments of the disclosed technology have been described with particular specifics and varying details for illustrative purposes, those skilled in the art will appreciate that various modifications, additions and substitutions may be made based on what is disclosed or illustrated in the disclosed technology without departing from the spirit and scope of the disclosed technology as defined in the following claims. Furthermore, the embodiments may be combined to form additional embodiments.

What is claimed is:

1. A data storage device comprising:
at least one memory device including a plurality of memory regions; and
a controller configured to, when receiving a virtual machine migration command from a first virtual machine among a plurality of virtual machines operating in a first host device among a plurality of host devices, set at least one memory region other than a first memory region allocated to the first virtual machine among the plurality of memory regions, as a temporary memory region, and migrate data stored in the first memory region and corresponding to the virtual machine migration command, to the temporary memory region.

2. The data storage device according to claim 1, wherein, when migration of the data is completed, the controller allocates the temporary memory region to a second virtual machine which operates in a second host device different from the first host device.

3. The data storage device according to claim 2, wherein, when migration of the data is completed, the controller transmits a migration completion signal to the first host device.

4. The data storage device according to claim 3, wherein, after transmitting the migration completion signal, the controller allocates the temporary memory region in response to an allocation request received from the second virtual machine which operates in the second host device.

5. The data storage device according to claim 1, wherein the temporary memory region is a memory region which is not allocated to the plurality of host devices, or the temporary memory region is a part of memory regions allocated to the second virtual machine which operates in the second host device different from the first host device.

6. The data storage device according to claim 1, wherein the controller traces update of the data corresponding to the virtual machine migration command by the first virtual machine operating in the first host device while the data is migrated.

7. The data storage device according to claim 6, wherein, when migration of the data is completed, the controller migrates to the temporary memory region the data updated by the first virtual machine operating in the first host device.

8. The data storage device according to claim 7, wherein, when a time period required to migrate the updated data is equal to or shorter than a preset threshold period, the controller migrates the data in a state in which control of the first virtual machine operating in the first host device for the data corresponding to the virtual machine migration command is stopped.

9. The data storage device according to claim 1, further comprising:
a data migration controller configured to operate under control of the controller and perform a migration operation of the data.

10. The data storage device according to claim 1, wherein the controller receives, from the first host device, additional data which is stored in a local memory adjacent to the first host device and corresponds to the virtual machine migration command.

11. The data storage device according to claim 10, wherein, when receiving the additional data, the controller stores the additional data in the first memory region and migrates the additional data to the temporary memory region.

12. The data storage device according to claim 10, wherein, when migration of the data is completed, the additional data is migrated to a local memory which is adjacent to the second host device different from the first host device.

13. A computing system comprising:
a first host device;
a second host device; and
a data storage device configured to set, when receiving a virtual machine migration command from a first virtual machine operating in the first host device, at least one memory region other than a first memory region allocated to the first virtual machine, as a temporary memory region, migrate data stored in the first memory region and corresponding to the virtual machine migration command, to the temporary memory region, and allocate, when migration of the data is completed, the temporary data region to a second virtual machine operating in the second host device.

14. The computing system according to claim 13, wherein the data storage device traces update of the data corresponding to the virtual machine migration command by the first virtual machine operating in the first host device while the data is migrated, and additionally migrates updated data.

15. The computing system according to claim 13, wherein, when receiving a migration pre-completion signal from the data storage device, the first host device stops work by the first virtual machine related with the virtual machine migration command.

16. The computing system according to claim 13, wherein, when receiving a migration completion signal from the data storage device, the first host device transfers the migration completion signal to the outside of the data storage device.

17. A data storage device comprising:
at least one memory device including a plurality of memory regions; and
a controller coupled to at least one host device, and configured to control the at least one memory device,
wherein, when receiving a memory region allocation request from a first virtual machine among one or more virtual machines operating in a first host device among the at least one host device, the controller allocates a first memory region among the plurality of memory regions to the first virtual machine, and updates ownership information of the first memory region, and
wherein, when receiving an ownership change request for the first memory region from the first virtual machine, the controller changes the ownership information of the first memory region and transmits a change completion message to the first host device.

18. The data storage device according to claim 17, wherein, after receiving the ownership change request, the controller generates an ownership change request acknowledgement signal corresponding to the ownership change request and transmits to the first host device the ownership change request acknowledgement signal as the change completion message.

19. The data storage device according to claim 17, wherein, after receiving the ownership change request, the controller generates an ownership change request acknowledgement signal corresponding to the ownership change request and transmits to the first host device the ownership change request acknowledgement signal before transmitting the change completion message.

20. The data storage device according to claim 17, wherein the controller transmits, in response to the ownership change request, at least one of the change completion message and information of the first memory region to a second host device which takes over ownership of the first memory region among the at least one host device.
